(19) United States
(12) Patent Application Publication
(10) Pub. No.: US 2015/0252995 A1
(43) Pub. Date: Sep. 10, 2015

(54) Semiconductor Light Module for a Headlight In Compact Design

(71) Applicant: Hella KGaA Hueck & Co., Lippstadt (DE)

(72) Inventors: Dieter Jestel, Castrop-Rauxel (DE); Sonia Martinez, Lippstadt (DE); Christian Neesen, Buren (DE); Heinz-Uwe Spork, Lippstadt (DE); Martin Metha Waga, Lippstadt (DE)

(21) Appl. No.: 14/638,897

(22) Filed: Mar. 4, 2015

(30) Foreign Application Priority Data
Mar. 5, 2014 (DE) 102014102867.8

(51) Int. Cl. F21V 29/67

(52) U.S. Cl. CPC F21V 29/677

(57) ABSTRACT

A semiconductor light module with at least one semiconductor light source and with a cooling body. The cooling body has a base section with a mounting side on which is mounted the semiconductor light source. The base section has a cooling side on which is arranged a cooling structure. A blowing unit is provided, which produces a forced convection of the cooling structure with blown air stream. An inventive deflection channel is provided and it is designed in such a manner that a deflection of the blown air stream by at least 90° between the air outlet direction of the blown air stream from the blowing unit and a flow direction of the blown air stream through the cooling structure are produced.

### CROSS REFERENCE

This application claims priority to German Application No. 10 2014 102867.8, filed Mar. 5, 2014, which is hereby incorporated by reference.

### FIELD OF TECHNOLOGY

The present invention relates to a semiconductor light module with at least one semiconductor light source with a cooling body, wherein the cooling body has a base section with a mounting side, on which the semiconductor light source is mounted and wherein the base section has a cooling side, on which is formed a cooling structure and wherein a blowing unit is provided, which produces a forced convection of the cooling structure with blown air stream.

### BACKGROUND

From DE 10 2010 002 664 A1 is known a semiconductor light module with semiconductor light sources, and the semiconductor light source is mounted in a direct arrangement on the mounting side of the cooling body. The mounting side is formed on the base section of the cooling body, and on the cooling side opposite to the mounting side of the base section is a cooling structure in the form of ribs. The thus formed semiconductor light module has however major construction dimensions, in particular because a blowing unit is provided, which produces a forced convection with blown air stream by the cooling structure. The blowing unit is designed as an axial fan, and the air outlet direction of the blown air stream from the blowing unit reaches without deflection the cooling structure of the cooling body. After leaving the cooling structure, the blown air stream is heated and can be used to defrost a light outlet panel of a headlight, in which the semiconductor light module is mounted.

It is a disadvantage that the semiconductor light module has major construction dimensions so that it cannot be incorporated in a headlight of any configuration, in particular not if, for example, the semiconductor light module must be pivoted in the housing of the headlight to allow the function of steerable beams.

From DE 10 2009 033 909 A1 is known another semiconductor light module with a semiconductor light source, and the semiconductor light source is mounted on the mounting side of a base section of the cooling body. The cooling body further contains a blowing unit, which is placed on the cooling side that is arranged on the mounting side of the base section. By means of the blowing unit, the cooling structure can be exposed to the blown air stream, wherein the cooling structure is formed on the cooling side of the base section of the cooling body. The blowing unit is mounted directly in the region of the cooling structure of the cooling body, whereby the cooling structure for the production of the convection and thus the production of the cooling of the cooling body is substantially reduced. The cooling capacity of the cooling body is thus lowered; however, if the blowing unit were removed from the cooling structure so that it could be designed with a larger surface, the result would be again a larger construction unit of the semiconductor light module with the above-identified disadvantages.

### SUMMARY OF THE INVENTION

The object of the invention is an improved further development of a semiconductor light module in compact design. The technical task is to provide a semiconductor light module, which has universally usable dimensions, and which, despite a compact design, allows a high light power due to a correspondingly high cooling capacity.

The invention includes the technical teaching in that a deflection channel is provided and designed in such a manner that it produces a deflection of the blown air stream of at least 90° between an air outlet direction of the blown air stream and the blowing unit and a flow direction of the blown air stream by the cooling structure.

Only using a special deflection channel between the air outlet side of the blowing unit and the flow-in side of the cooling structure of the cooling body can one achieve a particularly compact design of a semiconductor light module. Using the deflection channel, the blowing unit can be arranged on, and preferable also attached to, the back side of the cooling body. The air outlet direction, in which the cooling air leaves the blowing unit, need not necessarily coincide with the flow direction, in which the blown air streams against the cooling structure. The deflection channel can be so advantageously designed that an essentially complete flow through the cooling structure can be achieved without the cross-section of the air outlet side of the blowing unit having to coincide with the cross-section of the air inlet side of the cooling structure. With particular advantage, the deflection channel can produce a deflection of the blown air stream of 180° between the air outlet direction and the flow direction. Using a deflection channel with a deflection of the blown air stream of 180°, the guiding of the blown air stream can be folded, whereby the semiconductor light module can be designed in a particularly space-saving manner.

With further advantage, the base section of the cooling body can extend in a plane, wherein the cooling structure can have elevations, in particular cooling ribs or cooling elements, which extend out of the plane of the base section. The cooling ribs or the cooling elements can preferably extend from the surface of the cooling side about perpendicularly, and the cooling body can, for example, be made as a continuous casting component or as an extruded component, or the cooling body is made by a casting process. The cooling body is preferably made of aluminum. If cooling ribs or cooling elements are provided on the cooling side of the base section, they can receive the blown air stream transverse to their direction of extension for a particularly effective cooling. The deflection channel thus preferably opens laterally to the cooling structure and the flow direction of the blown air stream through the cooling structure runs about parallel to the surface of the cooling side of the base section and can particularly advantageously convectively cool it.

With further advantage, the cooling body can have a bottom section, and the bottom section can have an extension plane, which extends parallel to the extension plane of the base section. Between the two extension planes of the base section and the bottom section extends the cooling structure, and a bottom section of the cooling body has the advantage that the blowing unit is mounted on it. A further advantage consists in an improved guiding of the blown air stream through the cooling structure, because the cooling structure has no open lateral side, through which the blown air stream can prematurely leave the cooling structure, and the blown air stream flows through the entire length of the cooling structure.

Alternatively to the direct arrangement of the blowing unit on the cooling body, in particular on the bottom section of the cooling body, the blowing unit can be mounted on the cooling body also by means of the deflection channel. The deflection channel can be designed as a stamped and bent component or, for example, as a plastic molding component. The deflection channel can have a structure and a strength, which allow the mounting of the blowing unit on the cooling body by means of the deflection channel.

According to a further development, the semiconductor light module can have a cuboid base form, wherein the base form can be essentially determined by the mounting side of the base section, the blowing unit and/or the cooling structure and/or by the deflection channel. The cuboid base form has the package dimensions of the semiconductor light module, which can be designed as a cuboid or, for example, even a cube with three identical edge dimensions. The cuboid base form has a light-emitting side formed by the mounting side of the cooling body and designed to hold the semiconductor light source; on the side opposite to the mounting side of the cooling body the blowing unit can have a suction area.

With a particular advantage, the semiconductor light module can comprise a housing, which is formed by the cuboid base form in an essentially closed form. In the housing are arranged the cooling body with at least one semiconductor light source, the blowing unit and the deflection channel, wherein the deflection channel can also at least partially protrude from the housing.

The blowing unit can be formed, for example, by a radial fan, wherein the axis of rotation of the radial fan extends in a direction, which is formed by a surface normal on the base section or rather the bottom section of the cooling body. In this way, the radial fan can be arranged reclining on the rear side of the cooling body, whereby the construction dimensions of the semiconductor light module can be further minimized.

With further advantage, the deflection channel can be designed having an outflow cross-section, which corresponds to the lateral cross-section of the cooling structure. It is ensured that the blown air stream flows completely through the cooling structure. The downstream side of the cooling structure can be pointed in the direction of the plastic closure disc of the headlight in order to defrost it.

With further advantage, a damping plate can be provided, wherein the blowing unit can be, at least indirectly, mounted on the cooling body by means of the damping plate. The damping plate prevents the vibrations of the blowing unit from being transferred to the cooling body and thus to the semiconductor light source. This design ensures that the operation of the blowing unit does not negatively affect the light characteristics of the semiconductor light source. In particular, on the mounting side of the cooling body can be arranged a multitude of semiconductor light sources in a set array, and the semiconductor light sources in an array arrangement can produce a bright—dark boundary of dimmed headlights. In particular the production of a bright—dark boundary of a dimmed headlight requires a light accurateness, which must not be negatively affected by the operation of a blowing unit as a part of the semiconductor light module. The damping plate can be made, for example, of a foamed or similar material, whereby the vibrations but not the noise of the blowing unit can be dampened.

Finally, the deflection channel can be designed in such a manner that the blown air stream is moving in direct convection over the surface of the cooling side of the base section of the cooling body and in particular parallel to the cooling side. This ensures a particularly effective cooling of the base section of the cooling body, because the hot spot on the mounting side of the base section in the form of the semiconductor light source must be cooled. Only the advantageous design of the deflection channel achieves the particularly effective cooling of the mounting side of the cooling body.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a perspective view of a semiconductor light module with the features of the present invention.

FIG. 2 shows the embodiment of the semiconductor light module according to FIG. 1 in another perspective view.

FIG. 3 shows another embodiment of a semiconductor light module in a side view.

FIG. 4 shows the embodiment of the semiconductor light module according to FIG. 3 in a perspective view.

FIG. 5 shows another embodiment of the semiconductor light module in a side view.

FIG. 6 shows the embodiment of the semiconductor light module according to FIG. 5 in a perspective view.

FIG. 7 shows a semiconductor light module in a side view.

FIG. 8 shows a perspective view of a semiconductor light module according to FIG. 7.

### DETAILED DESCRIPTION OF THE DRAWINGS

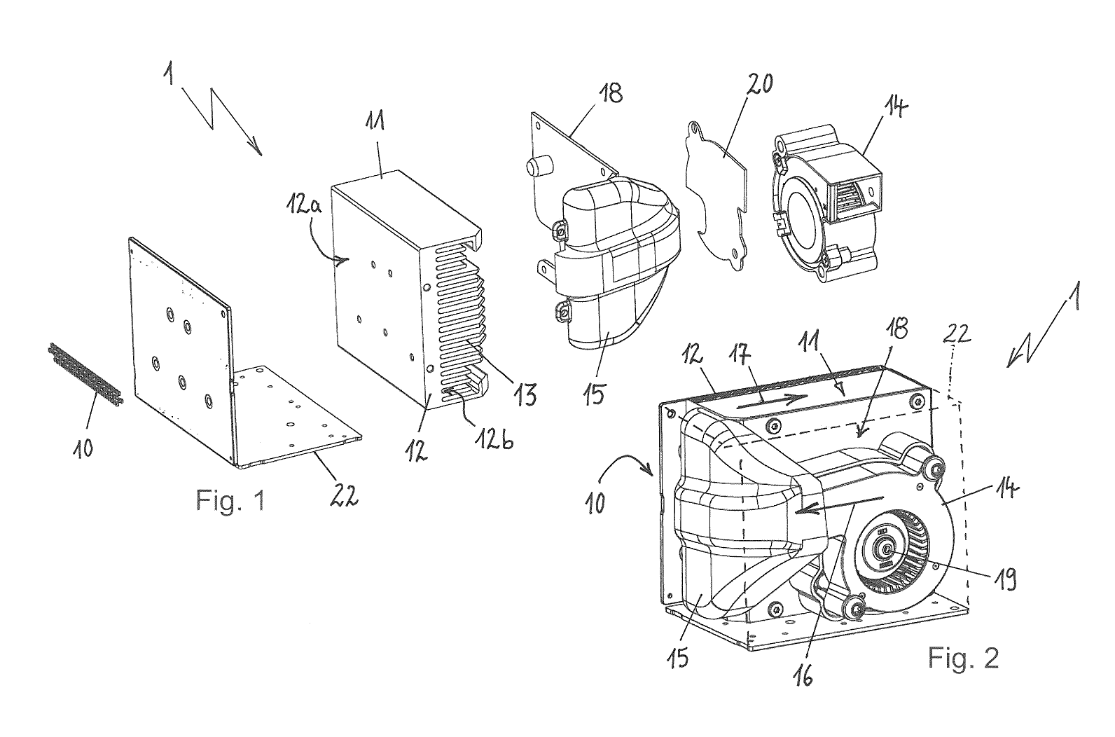

FIGS. 1 and 2 show in various perspective views a semiconductor light module 1 with the features of the present invention. The semiconductor light module 1 has an array consisting of a multitude of semiconductor light sources 10, and the semiconductor light sources 10 can fulfill a main light function, for example, dimmed headlights or a high beam of the headlights. The semiconductor light module 1 is incorporated in the housing of the headlight of a motor vehicle.

The semiconductor light module 1 comprises a cooling body 11 both as a carrier component and to fulfill the function of the base body, and the cooling body 11 also comprises a base section 12 having a mounting side 12a for the mounting of the semiconductor light source 10. The base section 12 extends in a plane, and on the cooling side 12b opposite to the mounting side 12a of the cooling body 11 is formed a cooling structure 13, which has lamellar cooling ribs. The cooling body 11 further comprises a bottom section 18, which closes the lamellar cooling structure 13 on the side that is opposite to the base section 12. The cooling structure 13 is therefore formed with several longitudinally extending chambers, which are subdivided by the ribs of the cooling structure 13.

On the rear side of the bottom section 18 is arranged a blowing unit 14 in the form of a radial fan and the blowing unit 14 produces a blown air stream, which leaves the blowing unit 14 in an air outlet direction 16. The blown air stream reaches a deflection channel 15, which follows the blowing unit 14 and which is designed in such a manner that the blown air stream is deflected by 180°. In this way, the blown air stream flows through the cooling structure 13 of the cooling body 11 in a flow direction 17, which runs opposite to the air outlet direction 16.

The rear-side arrangement of the blowing unit 14 on the cooling body 11 forms a compact construction unit, which includes a housing 22, in which are mounted the above-indicated components, and which has a cuboid base form.

The blowing unit 14 in the form of a radial fan has an axis of rotation 19 of a fan wheel and the axis of rotation 19 forms a surface normal on the base section 12 or rather on the bottom section 18 of the cooling body 11. As a result of the blown air stream leaving the blowing unit 14 about tangentially, and due to the vertical arrangement of the axis of rotation 19 of the fan wheel on the extension plane of the bottom section 18, the air outlet direction 16 runs first approximately parallel to the bottom section 18 of the cooling body 11 and it is only through the deflection channel 15 that the blown air stream is guided laterally into the cooling structure 13 of the cooling body 11.

The blowing unit 14 is mounted on the outer side of the bottom section 18 by means of the damping plate 20, whereby vibrations and noises, which develop during the operation of the blowing unit 14, are damped.

Due to the lateral introduction of the blown air stream into the cooling structure, convention is produced on the cooling side 12b of the base section 12 of the cooling body 11, whereby a particularly effective cooling of the mounting side 12a is achieved, on which the semiconductor light source 10 is mounted. Due to the inventive configuration of the semiconductor light source 10 with a deflection channel 15, which deflects the cooling air according to the shown embodiment by 180°, we obtain a small-size, compact unit of the semiconductor light module 1 with an cuboid housing 22, wherein a high cooling capacity can be achieved.

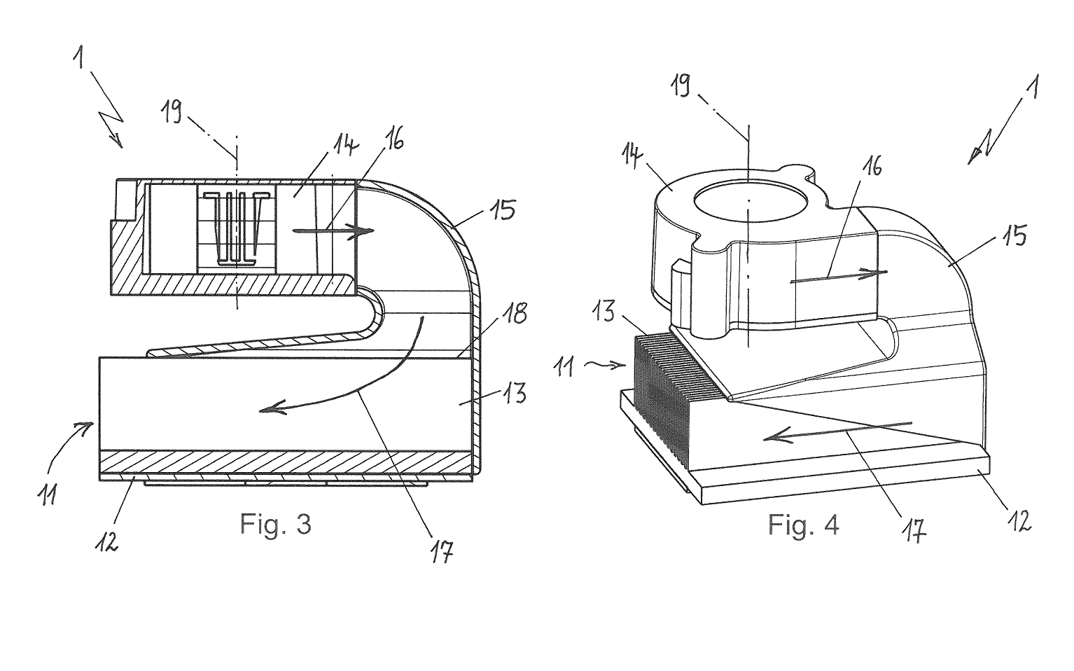

FIGS. 3 and 4 show another embodiment of the semiconductor light module with an alternative configuration of a deflection channel 15, and the embodiment shows the arrangement of the blowing unit 14 through the deflection channel 15 on the cooling body 11. The blowing unit 14 has an axis of rotation 19, which—as has already been described in context with the embodiment according to FIGS. 1 and 2—also in this embodiment forms a surface normal on the extension plane of the base section 12 of the cooling body 11.

The deflection channel 15 is designed in such a manner that it introduces the produced cooling air into the cooling structure 13 essentially over its whole width. The blown air stream leaves the blowing unit 14 first in the air outlet direction 16 and enters the deflection channel 15. The deflection channel 15 is essentially designed about U-shaped and forms with the cooling structure 13 and the bottom-side base section 12 a deflection area for the blown air stream by 180° so that the flow direction 17, in which the blown air stream is convecting through the base section 12 of the cooling body 11, which runs opposite to the outlet direction 16.

The shown bottom section 16, which is formed at a distance from the base section 12 of the cooling body 11 and includes the cooling structure 13, can have an opening or may be formed at a distance so that the blown air stream from the deflection channel 15 can enter the cooling structure 13.

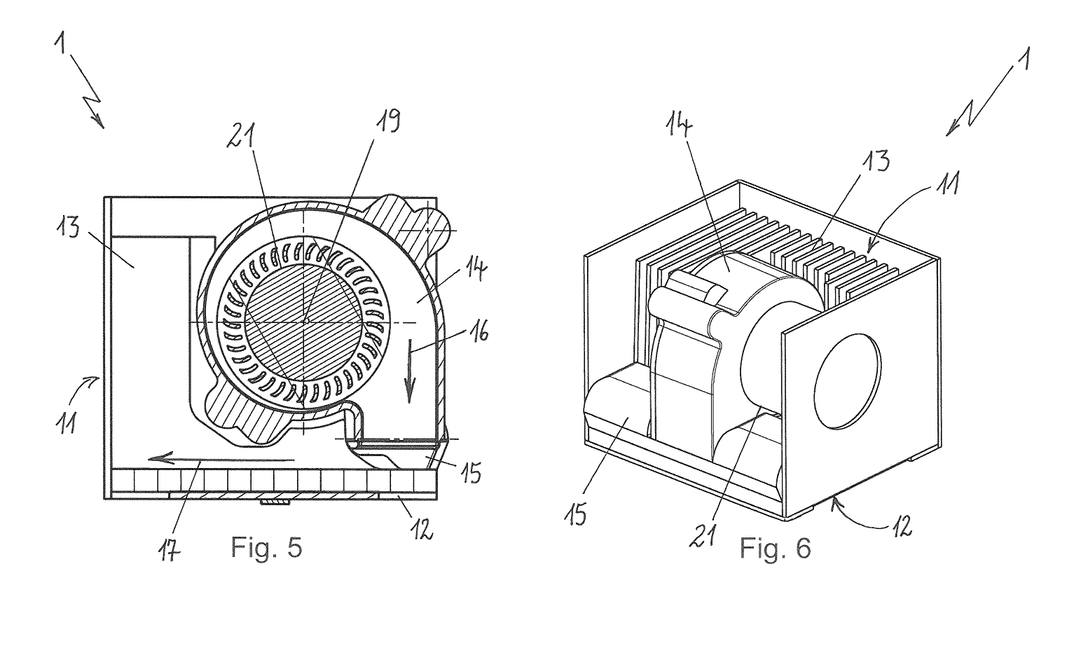

FIGS. 5 and 6 show another embodiment of a semiconductor light module 1 in a side view and in a top view, wherein according to this embodiment the deflection channel 15 deflects the blown air stream from the blowing unit 14 only by 90° so that the blown air stream, which leaves the blowing unit 14 in the air outlet direction 16, convects in the shown flow direction 17 through the base section 12 of the cooling body 11. According to shown embodiment, the cooling structure 13 has a mounting area for the arrangement of the blowing unit 14, and a suction channel 21 is also shown, through which the blowing unit 14 sucks in the blown air stream.

The deflection channel 15 extends over the entire width of the cooling structure 13, which is formed by a number of cooling ribs arranged parallel to each other, which extend out of the base section 12 of the cooling body 11. The axis of rotation 19 of the blowing unit 14 runs parallel to the extension plane of the base section 12 of the cooling body 11.

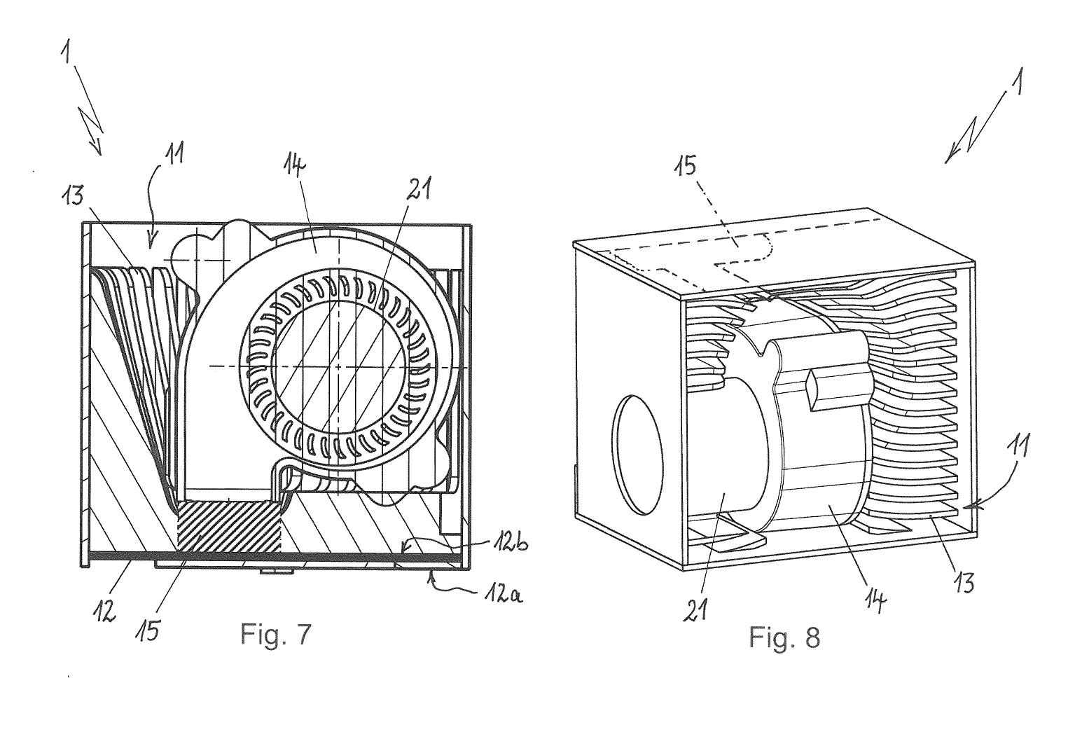

Finally, FIGS. 7 and 8 show another embodiment of the semiconductor light module 1 in a side view and in a perspective view. The embodiment shows the arrangement of the deflection channel 15 in a recess of the cooling structure 13 of the cooling body 11. The cooling structure 13 includes several cooling ribs formed parallel to each other, which have a gap for the arrangement of the deflection channel 15. The deflection channel 15 is mounted on the cooling side 12b of the base section 12, and the blowing unit 14 is arranged on the cooling body 11 by means of the deflection channel 15 together with the suction channel 21.

The shown configuration makes possible a direct impact of the air flow on an area of the base section 12 of the cooling side 12b, wherein the semiconductor light source 10 can be arranged directly on the mounting side 12a in the area of the deflection channel 15. As a result, it can be achieved that in particular at the spot of the introduction of the heat of the semiconductor light sources 10 into the cooling body 11, the base section 12 of the cooling body 11 is exposed to the air flow, whereby a particularly effective cooling of the semiconductor light source 10 is achieved.

The invention is not limited in its execution to the above-indicated preferred embodiment. Rather, there are a number of conceivable variants, which as a principle use the shown solution even in their differently configured versions. All features and/or advantages resulting from the claims, description or drawings, including design particulars, spatial arrangements and process steps, can be essential to the invention on their own as well as in various combinations.

### LIST OF NUMERAL REFERENCE SYMBOLS

1 Semiconductor light module
10 Semiconductor light source
11 Cooling body
12 Base section
12a Receiving side
12b Cooling side
13 Cooling structure
14 Blowing unit
15 Deflection channel
16 Air outlet direction
17 Flow direction
18 Bottom section
19 Axis of rotation
20 Damping plate
21 Suction channel
22 Housing

1. A semiconductor light module comprising:
at least one semiconductor light source;
a cooling body, wherein the cooling body has a base section, said base station including:
a mounting side on which the semiconductor light source is mounted, and
a cooling side, on which a cooling structure is arranged;
a blowing unit which produces a forced convection of the cooling structure with blown air stream,
wherein a deflection channel (15) is provided and so designed that it produces a deflection of the blown air stream of at least 90° between an air outlet direction of the air stream blown from the blowing unit and the flow direction of the blown air stream through the cooling structure.

2. The semiconductor light module according to claim 1, wherein the deflection channel produces a deflection of the blown air stream of 180° between the air outlet direction and the flow direction.

3. The semiconductor light module according to claim 1 wherein the base section of the cooling body extends in a plane and wherein the cooling structure has elevations, in particular cooling ribs or cooling elements, which extend out of the plane.

4. The semiconductor light module according to claim 1 wherein the cooling body has a bottom section and wherein the cooling structure extends between the base section and the bottom section, wherein the blowing unit is mounted in the bottom section.

5. The semiconductor light module according to claim 1 wherein the blowing unit is mounted on the cooling body through a deflection channel.

6. The semiconductor light module according to claim 1, having a cuboid base form, wherein the base form is determined by the mounting side of the base section, by the blowing unit and/or by the cooling structure and/or by the deflection channel.

7. The semiconductor light module according to claim 1, wherein the blowing unit comprises a radial fan, wherein the axis of rotation of the radial fan extends in a direction, which is formed by a surface normal on the base section or the bottom section of the cooling body.

8. The semiconductor light module according to claim 1, wherein the deflection channel is formed by an outflow cross-section, which corresponds to the side cross-section of the cooling structure.

9. The semiconductor light module according to claim 1, wherein a damping plate is provided, wherein the blowing unit is mounted at least by means of the damping plate on the cooling body.

10. The semiconductor light module according to claim 1, wherein the deflection channel is designed in such a manner that the blown air stream is moved by direct convection over the surface of the cooling side of the base section of the cooling body and in particular parallel to the cooling side.
